(19) United States
(12) Patent Application Publication
(10) Pub. No.: US 2026/0012130 A1
(43) Pub. Date: Jan. 8, 2026

(54) SOLAR PANEL MOUNTING BRACKET

(71) Applicant: APA SOLAR, LLC, Ridgeville Corners, OH (US)

(72) Inventors: Joseph Von Deylen, Whitehouse, OH (US); Josh Von Deylen, Bryan, OH (US); Shawn Jeremy Ramey, Ney, OH (US); Richard Alan Roth, Archbold, OH (US); Erik Steven Shinabery, Bryan, OH (US)

(21) Appl. No.: 19/262,660

(22) Filed: Jul. 8, 2025

Related U.S. Application Data
(60) Provisional application No. 63/668,359, filed on Jul. 8, 2024.

(51) Int. Cl. H02S 20/32

(52) U.S. Cl. CPC H02S 20/32

(57) ABSTRACT

A mounting bracket for mounting a bearing housing assembly to a solar panel foundation system is provided. The mounting bracket can include a body, a top panel, and side panels. The generally U-shaped body that can include the top panel and the side panels that can extend from the top panel. The top panel can be configured to directly receive the bearing housing assembly. Each of the side panels can include attachment apertures and adjustment apertures. The adjustment aperture can be configured to receive members of the solar panel foundation. The adjustment apertures can be lined with teeth to allow for adjustable positioning of the members of the solar panel foundation relative to the side panels.

### CROSS-REFERENCE TO RELATED APPLICATIONS

This application claims the benefit of U.S. Provisional Application No. 63/668,359, filed on Jul. 8, 2024. The entire disclosure of the above application is incorporated herein by reference.

### FIELD

The present technology relates to structural components for solar installations, and, more particularly, a solar panel mounting bracket.

### INTRODUCTION

This section provides background information related to the present disclosure which is not necessarily prior art.

In a solar energy application, the effectiveness and durability of a mounting system is important for the performance and longevity of a solar panel. Certain mounting systems can employ an I-beam structure as a foundational support, to which additional components such as a bracket and a fastener are attached. The additional components, such as the bracket or the fastener secure to a bearing housing assembly (BHA), which supports a tracker torque tube that adjusts the orientation of the solar panel. The configuration, however, presents certain challenges. The use of numerous separate components increases the complexity of the mounting system and raises the potential for mechanical failure. Each bracket and fastener creates a potential failure point and necessitates regular maintenance and inspection to maintain system integrity. The assembly process is also labor-intensive and requires careful alignment and securement of each component.

The adoption of a universal mounting bracket for a mounting system to accommodate different types of trackers adds further complexity. Although such a universal mounting bracket can offer versatility, making the mounting system compatible for various types of trackers often requires additional brackets and fasteners to adapt the system to various tracker specifications, potentially compromising structural integrity and operational efficiency. The environmental impact associated with the production and disposal of these additional components is also significant. The manufacture of extra brackets and fasteners consumes more resources and results in increased emissions and waste. As the solar industry expands, the environmental implications of its infrastructure become more pressing.

There is a continuing need for a simplified and more reliable mounting system for solar panels that addresses the inefficiencies and complexities of existing designs. Desirably, a system that reduces the number of brackets and fasteners would decrease potential failure points, reduce assembly time, and minimize environmental impact. Such improvements would enhance the durability and reliability of solar installations and support the sustainability of the solar energy sector.

### SUMMARY

In concordance with the instant disclosure, a simplified and more reliable mounting system for solar panels that addresses the inefficiencies and complexities of existing designs, has surprisingly been discovered. The present technology includes articles of manufacture, systems, and processes that relate to a solar panel mounting bracket and a solar panel foundation system.

In certain embodiments, a mounting bracket for mounting a bearing housing assembly to a solar panel foundation system can include a body, a top panel, and side panels. The body can be generally U-shaped body and can include the top panel and the side panels. The side panels can extend from the top panel. The top panel can be configured to directly receive the bearing housing assembly. The top panel can include an aperture that can be formed thereon and arranged to align with a corresponding component of the bearing housing assembly for securing the bearing housing assembly directly to the top panel. Each of the side panels can include attachment apertures and adjustment apertures. The adjustment aperture can be configured to receive members of the solar panel foundation. The adjustment apertures can be lined with teeth to allow for adjustable positioning of the members of the solar panel foundation relative to the side panels.

In certain embodiments, a mounting bracket for mounting a bearing housing assembly to a solar panel foundation system can include a body, a top panel, and side panels. The body can be generally U-shaped and can include the top panel and the pair of side panels. The side panels can extend from the top panel. The U-shaped body can be formed as a unitary body. The top panel can be configured to directly receive the bearing housing assembly and can include an aperture that can be formed thereon and arranged to align with a corresponding component of the bearing housing assembly for securing the bearing housing assembly directly to the top panel. The top panel can have a top panel width. Each of the side panels can include an angled wall, attachment apertures, and adjustment apertures that can be configured to receive members of the solar panel foundation. The adjustment apertures can be lined with teeth to allow for adjustable positioning of the members of the solar panel foundation relative to the side panels. The angled walls can taper inward from the top panel to the side panels with an interior angle relative to the top panel. The mounting bracket can have an interior width that can be defined as the distance between inner surfaces of the opposing side panels. The top panel width can be greater than the interior width.

In certain embodiments, a solar panel foundation system can include a mounting bracket, as described herein. The solar panel foundation system can include a first member that can be pivotably coupled to the adjustment aperture and a second member that can be pivotably coupled to the adjustment aperture.

In certain embodiments, a method of positioning a solar panel foundation system having a solar panel mounted to the solar panel foundation system via a bearing housing assembly. The method can include providing a solar panel foundation system with the solar panel mounted to the solar panel foundation system. The solar panel foundation system can include a first member, a second member, and a mounting bracket. The method can further include positioning the first member within the first adjustment aperture and positioning the second member within the second adjustment aperture, whereby the solar panel foundation system can be positioned.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of a mounting bracket;

FIG. 2 is a bottom perspective view of the mounting bracket;

FIG. 3 is a side elevational view of the mounting bracket;

FIG. 4 is a front elevational view of the mounting bracket;

FIG. 5 is a bottom plan view of the mounting bracket;

FIG. 6 is a top plan view of the mounting bracket;

FIG. 7 is a perspective view of a solar panel foundation system including the mounting bracket;

FIG. 8 shows the mounting bracket coupled to the solar panel foundation system taken at call-out A of FIG. 7;

FIG. 9 is a front elevational view of the solar panel foundation including the mounting bracket, wherein members of the solar panel foundation can be disposed at varying angles;

FIG. 10 is a schematic diagram of the solar panel foundation system, the mounting bracket, a bearing housing assembly, and a solar panel; and

FIG. 11 is a flowchart depicting a method of positioning a solar panel foundation system having a solar panel mounted to the solar panel foundation system via a bearing housing assembly.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the efficiency and reliability of a solar panel installation by introducing an A-frame that directly incorporates a mounting hole for a tracker bearing housing assembly (BHA), which can reduce the need for a separate bracket and/or fastener, reducing the number of components and potential failure points. Consequently, the assembly process can be simplified, reducing labor costs and installation time. Additionally, the streamlined design can minimize the environmental impact by decreasing the amount of raw materials used and waste generated. Overall, the present technology enhances the structural integrity and operational stability of a solar mounting system.

The bearing housing assembly can serve as the mounting interface between the solar panel and the solar panel foundation system. The bearing housing assembly can hold a tracker torque tube, which can be the structural element that supports and rotates the solar panel.

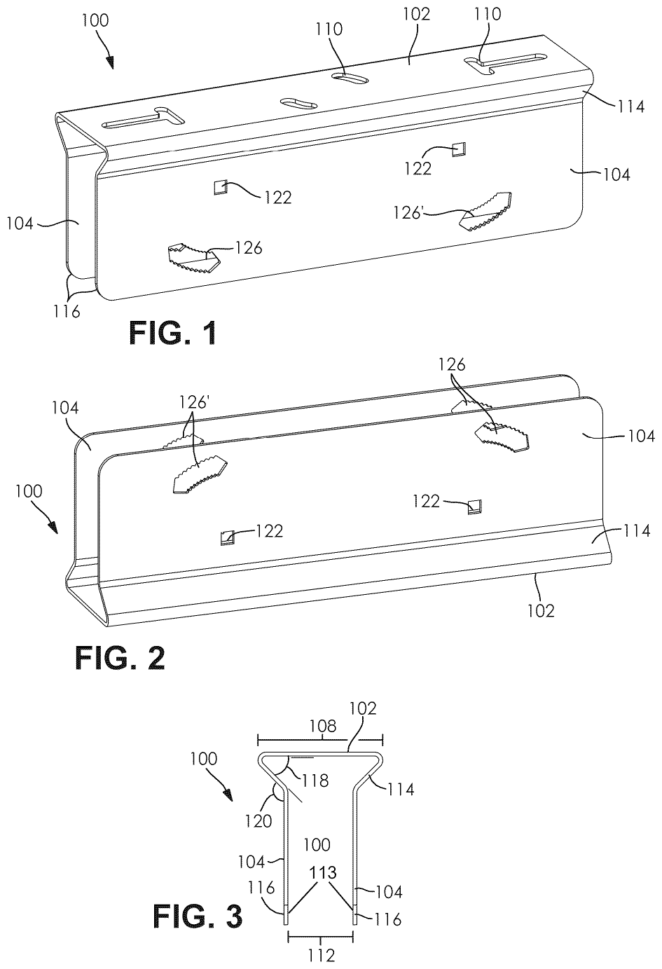

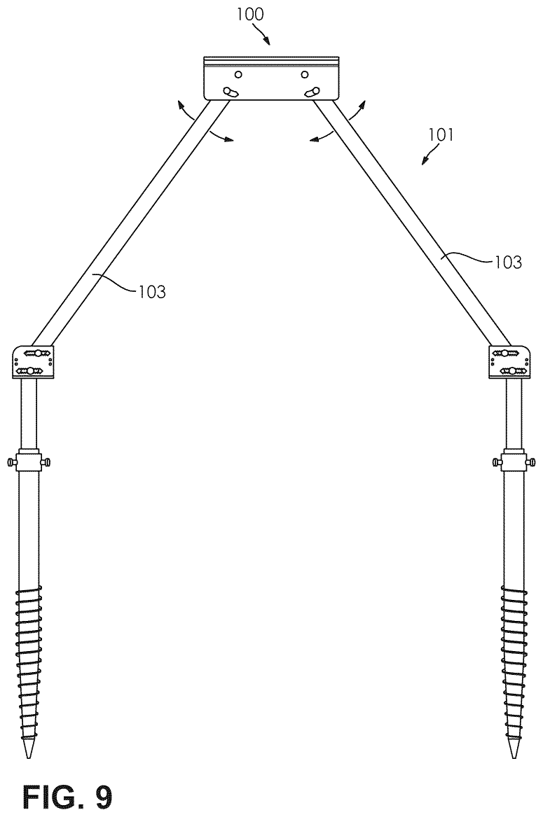

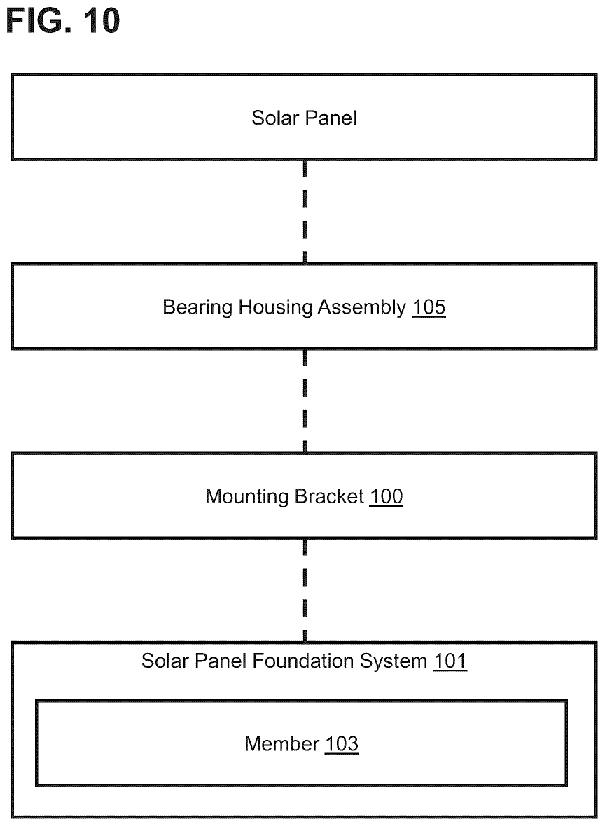

With reference to FIGS. 1-10, a mounting bracket 100 for a solar panel is shown. The mounting bracket 100 can be utilized with certain solar panel foundation systems 101. For example, reference is made to U.S. Patent Application Publication No. US 2023/0332368, published on Oct. 19, 2023, the entire disclosure of which is incorporated herein by reference. The referenced patent application describes a solar panel foundation system 101 that includes a bracket, braces, and members 103, which can serve as a basis for the enhancements detailed in this document. It should be appreciated that the mounting bracket 100 of the present disclosure can be utilized within other solar panel foundation systems 101 within the scope of the present disclosure.

With reference to FIGS. 1-3, the mounting bracket 100 can be generally U-shaped including a top panel 102 and a pair of side panels 104. The U-shaped configuration can provide a structural foundation that optimizes both functionality and manufacturing efficiency. As shown in FIGS. 1-2, each of the side panels 104 can extend from the top panel 102, creating a continuous structural element that can distribute loads effectively throughout the mounting bracket 100. The integrated structure can militate against the need for separate connecting elements between the top panel 102 and side panels 104, thereby reducing potential failure points and simplifying the overall assembly process and use of the mounting bracket 100.

As shown in FIG. 1, the mounting bracket 100 can be formed as a unitary body. The mounting bracket 100 can be manufactured from a single piece of material using a stamping and folding operation to create the generally U-shaped body. The stamping process can create a flat pattern with all necessary apertures, which can be folded into the geometry of the mounting bracket 100, as described herein. In an alternative embodiment, the mounting bracket 100 can be formed from different pieces where the top panel 102 and the side panels 104 can be independently formed and subsequently coupled through various permanent connection means. The separate components can be joined through a welding process, such as MIG welding, TIG welding, or spot welding, for example, depending on the material selected and the structural requirements of the mounting bracket 100. Other permanent connection means can include brazing, adhesive bonding with a structural adhesive, a mechanical fastening with rivets or bolts, or other metallurgical joining processes that can create a permanent bond between the top panel 102 and the side panels 104.

The mounting bracket 100 can be constructed from a rust-proof material suitable for outdoor solar installation. The mounting bracket 100 can be formed from stainless steel, which can provide corrosion resistance properties. Alternatively, the mounting bracket 100 can be manufactured from aluminum alloy that can offer lightweight characteristics while maintaining durability. Galvanized steel can also serve as an effective material option, providing strength characteristics with enhanced corrosion protection. The mounting bracket 100 can further include a weather-resistant coating, including a corrosion-proof coating such as powder coating, zinc plating, or other protective finishes that can create a barrier against environmental elements including moisture, salt air, and temperature fluctuations. A skilled artisan can select a suitable material for the mounting bracket 100 within the scope of the present disclosure.

It should be appreciated that the mounting bracket 100 can be constructed from a rigid material that can maintain structural integrity throughout the operational life of the mounting bracket 100. While the forming process can involve controlled folding to achieve the desired geometry, the mounting bracket 100 can resist deformation during use. The rigidity can be advantageous given that the mounting bracket 100 can be configured to directly receive a bearing housing assembly 105 of a solar panel foundation without intermediate brackets or fasteners, requiring the mounting bracket 100 to maintain alignment of the apertures and withstand operational loads imposed by the solar panel. The structural stability that can be provided by the rigid construction can facilitate reliable performance.

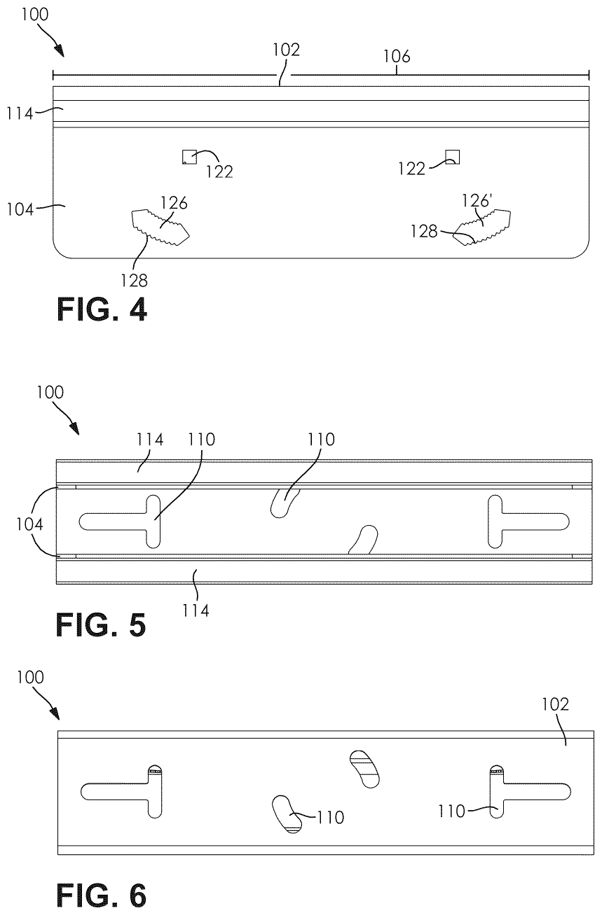

The top panel 102 can have a top panel length 106, as shown in FIG. 4, which can be dimensioned to ensure that the bearing housing assembly 105 is adequately supported and can be securely affixed to the mounting bracket 100. The top panel length 106 can be configured to provide sufficient surface area to accommodate any apertures of the top panel 102 that can be used for coupling that bearing housing assembly 105 to the mounting bracket 100. The top panel 102 can evenly distribute the weight of the bearing housing assembly 105 and solar panel across the mounting bracket 100, militating against localized stress concentrations that could lead to material failure or deformation. By providing a predetermined top panel length 106, the top panel 102 can create multiple load paths that can transfer forces from the bearing housing assembly 105 through the mounting bracket to the solar panel foundation system 101 members 103. The top panel length 106 can also provide a stable surface for the bearing housing assembly 105 that can resist torsional and bending moments generated during operation.

With reference to FIG. 3, the top panel 102 can have a top panel width 108 for facilitating even distribution of a load across the width dimension of the mounting bracket 100, creating multiple load paths that can transfer forces from the bearing housing assembly 105 through the top panel 102 to the side panels 104 and ultimately to the solar panel foundation system 101. The top panel width 108 can be varied depending upon the specific bearing housing assembly 105 to be mounted, allowing for customization to accommodate different tracker manufacturers and bearing housing assembly 105 configurations. The top panel width 108 can include a predetermined width to enable the mounting bracket 100 to be optimized for specific applications while maintaining a direct mounting capability.

The top panel 102 of the mounting bracket 100 can include one or more apertures 110 formed therethrough, as shown in FIGS. 1 and 6. The apertures 110 can be positioned on the top panel 102 to accommodate various bearing housing assemblies. The apertures 110 can be shaped and/or arranged to cooperate with one or more particular bearing housing assemblies to be mounted on the top panel 102, allowing for customization of the mounting pattern to match specific tracker requirements and manufacturer specifications. The flexibility of the placement of the apertures 110 can enable the mounting bracket 100 to accommodate different bearing housing assembly 105 configurations while maintaining the direct connection capability that militates against intermediate components.

Each aperture 110 can receive a fastener and a component from the bearing housing assembly 105 in order to secure the bearing housing assembly 105 directly to the top panel 102. The apertures 110 can be precisely sized and positioned to align with corresponding mounting points on the bearing housing assembly 105, ensuring proper load transfer and secure attachment. As an example, the fastener can include a bolt, a screw, or another mechanical fastening element that can pass through the apertures 110 and engage with threaded or other receiving features in the bearing housing assembly 105 components. Direct engagement between the fastener and the top panel 102 apertures 110 can create a rigid connection that can withstand the operational loads imposed by the solar panel.

The U-shape of the mounting bracket 100 can allow for clearance of the fasteners for the bearing housing assembly 105, which can allow for easy mounting to the top panel 102. The clearance can be provided by the open configuration created by the side panels 104 extending downward from the top panel 102, creating an accessible space beneath the top panel 102 for tool access during installation. The U-shaped geometry can facilitate the insertion and tightening of fasteners from below the top panel 102, enabling an efficient assembly procedure without interference from structural elements. Additionally, the clearance can accommodate any protruding components or hardware from the bearing housing assembly 105 that may extend below the mounting surface.

As shown in FIG. 3, the side panels 104 can include an interior width 112 defined as the distance between the inner surfaces 113 of the opposing side panels 104, creating the internal space within the mounting bracket 100. The interior width 112 can be varied to account for various members 103 of the various solar panel foundation systems 101, allowing the mounting bracket to be customized for different solar panel foundation systems 101 and support member specifications. In certain embodiments, the top panel width 108 can be approximately double the interior width 112. A skilled artisan can select a suitable interior width 112 and a suitable top panel width 108 within the scope of the present disclosure.

With continued reference to FIG. 3, the side panels 104 can include angled walls 114 that can provide structural support in operation. The angled walls 114 can allow the mounting bracket 100 to generally taper such that the top panel 102 can be relatively wider than free ends 116 of the mounting bracket 100. The tapering of the angled walls 114 can be achieved through the controlled forming processes during manufacturing, where the angled walls 114 can be shaped to create the optimal geometry of the mounting bracket 100. The angled walls 114 can also contribute to the overall rigidity of the mounting bracket 100 by creating a truss-like structure that can resist bending and torsional forces encountered during operation.

With further reference to FIG. 3, the angled walls 114 can be disposed at an interior angle 118 relative the top panel 102. The interior angle 118 can allow for the top panel 102 to have a depth suitable for the bearing housing assembly 105 while the free ends 116 can have a different width to accommodate the members 103 of the solar panel foundation system 101. In a particular embodiment, the interior angle 118 can be between about 30° and about 60°. In a more particular embodiment, the interior angle 118 can be between about 40° and about 50°. In a most particular embodiment, the interior angle 118 can be about 45°. Advantageously, the interior angle 118 can allow the mounting bracket 100 to accommodate the members 103 of the solar panel foundation system 101 and the bearing housing assembly 105 for mounting the solar panel.

With continued reference to FIG. 3, the angled walls 114 can be disposed at an exterior angle 120 relative to the side panels 104. The exterior angle 120 can allow for the top panel 102 to have a depth suitable for the bearing housing assembly 105 while the free ends 116 can have a different width to accommodate the members 103 of the solar panel foundation system 101. In a particular embodiment, the exterior angle 120 can be between about 120° and about 150°. In a more particular embodiment, the exterior angle 120 can be between about 130° and about 140°. In a most particular embodiment, the exterior angle 120 can be about 135°. Most importantly, the interior angle 118 and the exterior angle 120 can be supplementary angles such that the interior angle 118 and the exterior angle 120 can equal approximately 180°.

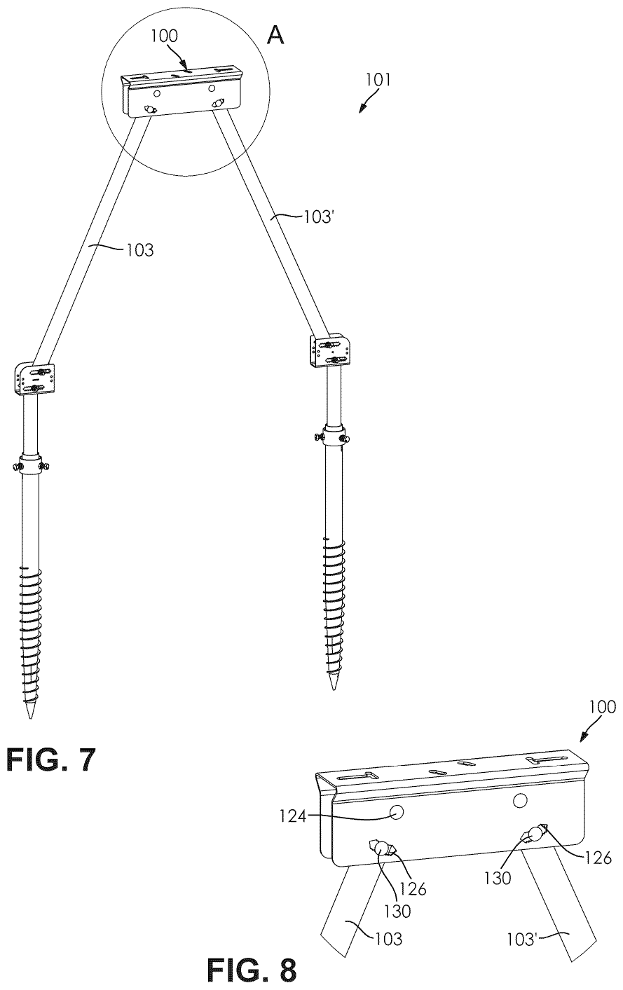

The shape of the mounting bracket 100 can facilitate the mounting bracket 100 receiving the members 103 within the U-shape, as shown in FIGS. 7-9, creating a secure and functional connection that enables the mounting bracket 100 to interface directly with the solar panel foundation system 101. For this purpose, the side panels 104 can also include a connection aperture 122 for securing the members 103 of the solar panel foundation system 101 to the mounting bracket 100, providing at least one connection point that can accommodate various installation requirements and load conditions. The connection aperture 122 can be strategically positioned on the side panel 104 to align with corresponding features on the member 103, ensuring proper load transfer and structural continuity throughout the mounting system.

The members 103 can be pivotable in the mounting bracket 100 in operation, allowing for angular adjustment and alignment flexibility during installation and throughout the operational life of the solar panel foundation system 101. The pivotable nature of the members 103 within the mounting bracket 100 can allow the solar panel foundation system 101 to accommodate site-specific elevation requirements and ensuring optimal alignment of the mounting bracket 100 according to the specific installation conditions. The pivotable nature of the mounting bracket 100 can enable the mounting bracket 100 to adapt to varying terrain conditions and foundation orientations while maintaining the structural integrity of the connection between the bearing housing assembly 105 and the solar panel foundation system 101.

As shown in FIG. 8, the members 103 can be affixed to the mounting bracket 100 with a connection fastener 124 that can be inserted through the connection aperture 122 of one side panel 104, the member 103, and the other connection aperture 122 of the other side panel 104, thereby securing the member 103 to the mounting bracket 100. The through-fastening configuration can create a robust mechanical connection that can resist both tensile and shear forces imposed during operation. The connection fastener 124 can militate against the need for separate attachment hardware on each side panel, simplifying the assembly process while providing superior load-carrying capacity compared to a single-sided fastening method. The through-fastening configuration can also facilitate easier installation and maintenance access, as the connection fastener 124 can be accessible from either side of the mounting bracket 100. Various connection fasteners 124 can be employed with the solar panel foundation system 101 with the mounting bracket 100 to provide secure connections. Examples of connection fasteners 124 include bolts, nuts, and washers, which provide strong mechanical linkage and are easy to install and inspect. Each type of fastener can be selected by a skilled artisan based on specific requirements such as load-bearing capacity, environmental resistance, and ease of maintenance.

The side panels 104 can include an adjustment aperture 126 that can allow for an adjustment of an angle of the members 103 within the mounting bracket 100, as shown in FIGS. 1, 2, 4, and 8. Each side panel 104 can include more than one adjustment aperture 126 to allow each member to be adjustable within the mounting bracket 100. The adjustment aperture 126 can provide the required flexibility for proper alignment and positioning of the solar panel foundation system 101 on any type of terrain. The angular adjustment capability provided by the adjustment aperture 126 can be essential for accommodating different terrain conditions, foundation orientations, and elevation requirements that can be encountered across various installation sites.

The adjustment aperture 126 can be lined with teeth 128 that can create a mechanical indexing system for angular positioning of the members 103 within the mounting bracket 100. The teeth 128 of the adjustment apertures 126 can allow for multiple predetermined set points for the angle of the members 103, providing discrete angular positions that can be reliably maintained under operational loads. The toothed configuration can militate against slippage or drift of the angular setting once the desired position is established, ensuring that the mounting bracket 100 maintains the intended alignment throughout the operational life of the solar panel. The teeth 128 can engage with corresponding features on fastening hardware or the members 103, creating a positive mechanical lock that can resist forces that might otherwise cause angular displacement.

The angular adjustment capability can allow for alignment of the mounting bracket 100 and the solar panel foundation system 101 based on the elevation and/or angle of a particular installation of solar panel foundation system 101. For example, the alignment flexibility can be particularly important for solar installation on a sloped terrain or where precise angular positioning is required to optimize solar panel performance. The adjustment aperture 126 can accommodate variations in site conditions while maintaining the structural integrity of the connection between the mounting bracket 100 and the solar panel foundation system 101. The ability to adjust the angle can also facilitate optimal alignment with the bearing housing assembly 105 mounted on the top panel 102.

The members 103 can have corresponding apertures that cooperate with the adjustment apertures 126 such that an adjustment fastener 130 can be inserted through one of the side panels 104, the member 103, and the other one of the side panels 104, thereby securing the member 103 to the mounting bracket 100. Various adjustment fasteners 130 can be employed with the solar panel foundation system 101 with the mounting bracket 100 to provide secure connections. Examples of adjustment fasteners 130 include bolts, nuts, and washers, which provide strong mechanical linkage and are easy to install and inspect. Each type of fastener can be selected by a skilled artisan based on specific requirements such as load-bearing capacity, environmental resistance, and ease of maintenance.

The mounting bracket 100 of the present disclosure can advantageously minimize the need for separate brackets and fasteners, which are typically required in certain known solar panel foundation systems 101. The mounting bracket 100 can simplify the assembly process, reduce the number of components and potential failure points, and enhance the overall structural integrity of the installation. By streamlining assembly, the mounting bracket 100 not only facilitates quicker and more cost-effective installations but also improves durability and resistance to environmental stresses. Furthermore, the reduction in material usage contributes to environmental sustainability, aligning with the growing demand for greener construction practices in the solar industry.

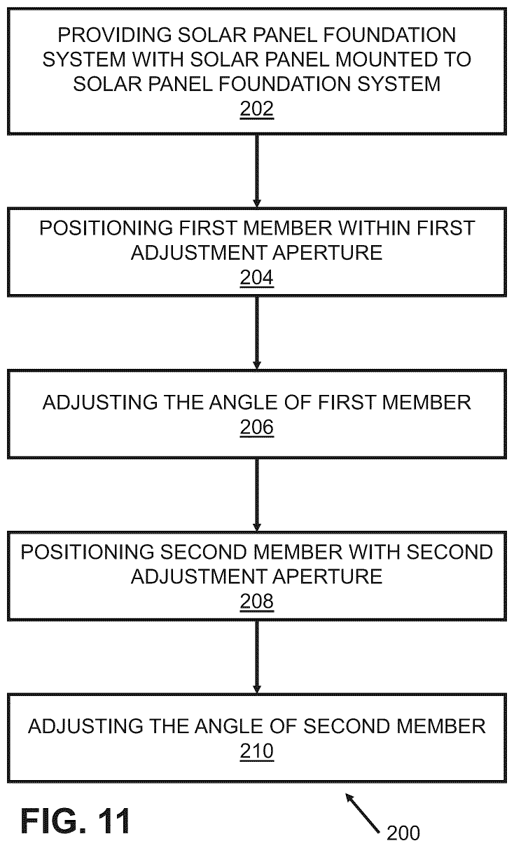

The present disclosure further provides a method 200 of positioning a solar panel foundation system 101 having a solar panel mounted to the solar panel foundation system 101 via a bearing housing assembly 105, shown generally in FIG. 11. The method 200 can include a step 202 of providing the solar panel foundation system 101 with the solar panel mounted to the solar panel foundation system 101 using the mounting bracket 100 as described herein. The solar panel foundation system 101 can include a first member 103, a second member 103′, and the mounting bracket 100.

The method 200 can include a step 204 of positioning the first member 103 within the first adjustment aperture 126. It should be appreciated that the first member 103 can be secured within the mounting bracket 100 using the adjustment fastener 130 adjacent the first adjustment fastener 130 such that the first member 103 can be pivotable within the mounting bracket 100 during operation. The step 204 of positioning the first member 103 can include adjusting the angle of the first member 103 within the mounting bracket 100 to accommodate specific elevation requirements of the installation site. The teeth 128 lining the first adjustment aperture 126 can allow for multiple set points for the angle of the first member 103, providing discrete angular positions that can be reliably maintained under operational loads. The teeth can engage with the first adjustment fastener 130 to retain the first member 103 in the desired position. The teeth 128 can militate against slippage or drift of the angular setting once the desired position of the first member 103 is established. In this way, the method 200 can include a step 206 of adjusting the angle of the first member 103 to accommodate specific elevation requirements.

The method 200 can likewise include a step 208 of positioning the second member 103′ within the second adjustment aperture 126′. The second member 103′ can be positioned in the same manner as the first member 103, with the ability to adjust the angle of the second member 103′ within the mounting bracket 100 based on the elevation and/or angle requirements of the particular installation. The second adjustment aperture 126′ can also be lined with teeth 128 that provide multiple set points for angular positioning of the second member, ensuring that both members can be independently adjusted to achieve proper alignment of the mounting bracket and the solar panel foundation system. It should be appreciated that the first member 103 and the second member 103′ can be positioned at different angles relative the mounting bracket 100. In this way, the method 200 can include a step 210 of positioning the second member 103′ includes adjusting the angle of the second member 103′ to accommodate specific elevation requirements.

The positioning of both the first member 103 and the second member 103′ with the respective adjustment apertures 126, 126′ can enable the mounting bracket 100 to accommodate varying installation conditions and site-specific requirements while maintaining structural integrity.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A mounting bracket for mounting a bearing housing assembly to members of a solar panel foundation system, comprising:
a generally U-shaped body including a top panel and a pair of side panels extending from the top panel;
the top panel configured to directly receive the bearing housing assembly, the top panel including an aperture formed thereon arranged to align with a corresponding component of the bearing housing assembly for securing the bearing housing assembly directly to the top panel; and
each of the side panels including attachment apertures and adjustment apertures configured to receive members of the solar panel foundation, the adjustment apertures lined with teeth to allow for adjustable positioning of the members of the solar panel foundation relative to the side panels.

2. The mounting bracket of claim 1, wherein the generally U-shaped body is formed as a unitary body.

3. The mounting bracket of claim 1, wherein the side panels include angled walls proximate the top panel.

4. The mounting bracket of claim 3, wherein the top panel has a top panel width, the mounting bracket has an interior width, and the top panel width is greater than the interior width.

5. The mounting bracket of claim 3, wherein each of the angled walls tapers inward from the top panel to the respective side panel.

6. The mounting bracket of claim 3, wherein the angled walls are disposed at an interior angle relative to the top panel.

7. The mounting bracket of claim 6, wherein the angled walls are disposed at an exterior angle relative to the side panels and the interior angle and the exterior angle are supplementary angles.

8. The mounting bracket of claim 1, wherein the side panels create an interior width defined as a distance between inner surfaces of the opposing side panels.

9. The mounting bracket of claim 1, wherein the teeth include multiple set points for independently disposing each of the members at an angle.

10. The mounting bracket of claim 1, wherein the top panel includes an aperture disposed therethrough for coupling the mounting bracket to the bearing housing assembly.

11. A mounting bracket for mounting a bearing housing assembly to members of a solar panel foundation system, comprising:
a generally U-shaped body including a top panel and a pair of side panels extending from the top panel, the U-shaped body formed as a unitary body;
the top panel configured to directly receive the bearing housing assembly, including an aperture formed thereon arranged to align with a corresponding component of the bearing housing assembly for securing the bearing housing assembly directly to the top panel, the top panel having a top panel width; and
each of the side panels including an angled wall, attachment apertures, and adjustment apertures configured to receive members of the solar panel foundation, the adjustment apertures lined with teeth to allow for adjustable positioning of the members of the solar panel foundation relative to the side panels, the angled walls tapering inward from the top panel to the side panels with an interior angle relative to the top panel,
wherein the mounting bracket has an interior width defined as a distance between inner surfaces of the opposing side panels and the top panel width is greater than the interior width.

12. A solar panel foundation system, comprising:
the mounting bracket of claim 1,
a first member pivotably coupled to one of the adjustment apertures; and
a second member pivotably coupled to another one of the adjustment apertures.

13. The solar panel foundation system of claim 12, wherein the first member is secured to the mounting bracket with a first adjustment fastener.

14. The solar panel foundation system of claim 13, wherein the second member is secured to the mounting bracket with a second adjustment fastener.

15. The solar panel foundation system of claim 14, wherein the first adjustment fastener and the second adjustment fastener each include a bolt.

16. The solar panel foundation system of claim 12, further including a bearing housing assembly directly mounted to the top panel.

17. A solar panel foundation kit, including:
the solar panel foundation system of claim 12; and
the bearing housing assembly.

18. A method of positioning a solar panel foundation system having a solar panel mounted to the solar panel foundation system via a bearing housing assembly and a mounting bracket:
providing the solar panel foundation system with the solar panel mounted to the mounting bracket via the bearing housing assembly, the solar panel foundation system including
a first member, a second member, and a mounting bracket including
a generally U-shaped body including a top panel and a pair of side panels extending from the top panel,
the top panel configured to directly receive the bearing housing assembly, including an aperture formed thereon arranged to align with a corresponding component of the bearing housing assembly for securing the bearing housing assembly directly to the top panel, and
each of the side panels including attachment apertures, a first adjustment aperture configured to receive the first member, and a second adjustment aperture configured to receive the second member, the adjustment apertures lined with teeth to allow for adjustable positioning of the first member and the second member relative to the side panels;
positioning the first member within the first adjustment aperture; and
positioning the second member with the second adjustment aperture, whereby the solar panel foundation system is positioned.

19. The method of claim 18, wherein the step of positioning the first member includes adjusting an angle of the first member to accommodate an elevation requirement.

20. The method of claim 18, wherein the step of positioning the second member includes adjusting an angle of the second member to accommodate another elevation requirement.
